(19) United States
(12) Patent Application Publication
(10) Pub. No.: US 2020/0397642 A1
(43) Pub. Date: Dec. 24, 2020

(54) FLEXURE BASED MOBILITY AID TIP

(71) Applicant: FLEXMOTIV TECHNOLOGIES PVT LTD., Chennai, Tamil Nadu (IN)

(72) Inventors: Arvind Suresh AMBALAPUZHA, Chennai (IN); Adepu SRINIVAS, Chennai (IN)

(73) Assignee: FLEXMOTIV TECHNOLOGIES PVT LTD., Chennai, Tamil Nadu (IN)

(21) Appl. No.: 16/968,482

(22) PCT Filed: Feb. 6, 2019
(86) PCT No.: PCT/IN2019/050093

§ 371 Date: Aug. 7, 2020

(30) Foreign Application Priority Data
Feb. 7, 2018 (IN) 201841004533

(51) Int. Cl. A61H 3/02

(52) U.S. Cl. CPC A61H 3/0277; A61H 2201/0192; A61H 2003/0211

(57) ABSTRACT

A mobility aid tip including a resilient toe flexure having a first toe end and a second toe end. A resilient heel flexure having a front heel end and a bottom heel end wherein the vertical plane of the mobility aid tip is offset with the axis of the mobility aid and the first toe end is positioned forwardly from the axis of the mobility aid. The bottom heel end is positioned rearward from the axis of the mobility aid. A toe pad secures the front toe end of the toe flexure and a heel pad secures the bottom heel end of the heel flexure.

### TECHNICAL FIELD

The present disclosure relates to a mobility aid for patients who are unable to walk without support. More particularly, the present disclosure relates to tip of the mobility aid where two resilient metal leaves are attached to from a structure which provides mechanical advantage, stability, multi-terrain grip to the users while walking with the mobility aid.

### BACKGROUND

Mobility is key for independent living. As per 2011 Census, people with locomotor disability contribute to 0.41% of the Indian population and the trend is disturbingly increasing. As of 2017, there are an estimated 50 Lakh people with locomotion disability. People with bilateral disability mostly use wheelchair whereas the people with unilateral disability, injury are advised to use a crutch. The crutch is the most straightforward and reliable way to compensate for the loss of mobility of these people supporting their body weight during locomotion in daily life. It provides a stable environment for recovery by allowing the injured limb in a load-free condition.

Crutches are of various types
Axillary or Underarm crutches—Used by patients with complete loss of strength in one leg only
Elbow or Lof strand crutches—Used by patients with partial or complete loss of strength in one or both legs
Platform Crutches—Used by any of the above patients who additionally have problems in the wrist.

Reference is made to U.S. Pat. No. 9,867,755, dated Jan. 16, 2018, titled “Ergonomic crutch” by Dalury, David F. This invention provides crutch comprising a series of elements angled with respect to each other to provide a stable platform for supporting a user's weight while reducing injury.

The crutch is comprising axillary support, an upper shaft segment having a first end and a second end, an intermediate shaft segment having a first end and a second end, and a lower shaft segment having a first end and a second end.

Another reference is made to the U.S. Pat. No. 9,808,392, dated Nov. 7, 2017, titled “Multi-mode hands-free crutch” by “The Board of Regents of the University of Texas System”. This crutch includes a base, one or more leg support members coupled to the base, and an axillary support member coupled to the base. The leg support members are configurable to at least partially the weight of a person through the person's leg. The axilla support member is configurable to extend under one of the user's arms to at least partially bear the weight of the person. The axilla support member may be adjustable to reversibly transform the crutch between axilla support of the person and leg support of the person. The crutch can be selectively configured for use in a hands-free walking mode, an axillary support mode, a sitting mode, or a compact mode. The axillary support member is adjustable to reversibly transform the crutch between axillary support of the person and leg support of the person and/or the axillary support member is telescopically adjustable with respect to the base.

Further reference is made to the U.S. Pat. No. 9,289,346, dated Mar. 22, 2016, titled “Ergonomic crutch” by Wisys Technology Foundation, Inc. This medical crutch has some bends in the frame for redistributing the amount of pressure applied to a user's hand, arm, and axillary.

The frame has a first jog outwardly sidewards relative to a user's body and a second jog outwardly forward relative to the user's body. The frame may attach an adjustable handle, forearm rest and underarm support, among other attachments. The frame is adapted to fit all average sizes by adjusting the positions of the attachments. The crutch is further comprising an S-curve formed in the elongate rod defined by a first bend outwardly forward relative to the human's body and a second bend backwards relative to the human's body. The S-curve is positionable forward relative to a human's arm when the human's forearm is received in the arm support.

Another reference is made to the U.S. Pat. No. 8,235,063, dated Aug. 7, 2012, titled “Multi-stage collapsible crutch” by Estrada, Jr.; Hector Mark. In this invention, a crutch is shown that may be collapsed for storage and shipment, adjustable for different users and mitigates the effect of the enrich striking the ground. A saddle support surface is coupled to two rails that extend and slide through a handrail and a wishbone.

The rails may be secured with respect to the handrail and wishbone in a variety of positions, enabling the distance between the support surface and the handgrip and the length of the crutch to be adjusted. Also, the rails may be positioned in the handrail and wishbone such that the support surface fits against the handrail and the handrail against the wishbone. A shock tube extends from and slides through the wishbone and may be secured in a variety of positions to adjust the length of the crutch to account for different users and to minimise the length for storage and shipment. The device is further comprising an axillary cushion attached to the saddle support.

The axillary cushion is colour-coded to represent different possible sizes of the device. There is a support tube comprising a plurality of markings, each marking indicating a configured length of the device corresponding to a specific position of the plurality of positions associated with the support tube and the wishbone.

A further reference is made to the U.S. Pat. No. 6,386,217, dated May 14, 2002, titled “Axillary crutch” by McMaster University. This invention provides an assistive device for persons with an injured or disabled leg includes a main body comprising a crutch to which is pivotally attached a supporting structure. To assist the person in walking, the device can be used as a crutch in a known manner, and the supporting structure is maintained in the same plane as the crutch. When the person wishes to be seated, one end of the device is placed on the seat adjacent the person, and the supporting structure of the device is pivoted out of the plane of the crutch to provide support for the opposite end. In this manner, the crutch is positioned in a generally horizontal position and serves as elongate support for the injured leg whereby the leg is maintained in a horizontal position while the person is seated.

All the above traditional/conventional crutch comprises of a rigid strut to handle the weight of the user and tip made out of soft polymer/rubber in shape below as illustrated in FIG. 1(a) and FIG. 1(b). The polymer material is intended to grip the walking surface and provide a minimum cushioning effect during usage. These tips are designed primarily for walking on even and hard surfaces. Using these crutches on rough walking surfaces found in developing reduces the usable lifespan of these tips and demands a regular replacement. This is of particular significance to users in the developing countries such as India where the walking surfaces are harsh and rough, and the people are not economically strong to replace the rubber tips on a regular basis.

Also, these tips have usability issues when it comes to walking on muddy, sandy and other such surfaces. These tips can slip in muddy surfaces as shown in FIG. 3 (a) and possibly cause the user to fall and injure himself. These tips can also get buried in sandy or damp soil as shown in FIG. 3 (b) requiring extra effort by the user to pull it out.

Given that these tips deform to a minimum, they almost work like rigid body, transmitting majority of the jarring forces of motion to the user's body. On long term usage, these forces may cause back pain, stress-induced bone deformation, nerve damage (especially radial and carpal nerves) due to compression. Additionally, the rigid nature of the tip and the strut means that while walking the user's centre of gravity moves in a near-circular path with the tip-ground contact point as center. The vertical component of this motion demands additional energy which is dissipated during the heel strike. This additional energy could have been put to more productive use. Given that most of India's and other developing countries disabled and injured are in their youth phase when physiological growth is high, the above-given effects can lead to permanent deformation and lower productivity in life. The above effects are drastically magnified when the user inadvertently uses improper techniques of the mobility aid.

To sum it up, the significant disadvantages of the tips in the prior art are as follows.
1. Low Stability and during usage due to small ground contact area.
2. High wear and tear in rough surfaces
3. Low surface grip
4. High energy requirement

The devices in the patents referred previously, and the ones available in the market are plagued by the problems mentioned and does not provide a mechanism and system as covered by the scope of the present disclosure. The disclosure below provides a mobility aid tip that can be used with any of the mobility aid that exists (elbow crutch, Axillary crutch, platform crutches) and solves the problem mentioned above.

### SUMMARY

The present disclosure relates to a mobility aid tip (1) comprising a resilient toe flexure (2) having a first toe end (2a) and a second toe end (2b). A resilient heel flexure (3) having a front heel end (3a) and a bottom heel end (3b) wherein the vertical plane of the mobility aid tip (VP) is offset (θ) with the axis of the mobility aid (y-y) and the first toe end (2a) is positioned forwardly from the axis of the mobility aid (y-y). The bottom heel end (3b) is positioned rearward from the axis of the mobility aid (y-y). A toe pad (4) secures the front toe end (2a) of the toe flexure (2) and a heel pad (5) secures the bottom heel end (3b) of the heel flexure (3).

In an alternate embodiment, the present disclosure relates to a mobility aid tip (10) comprising a resilient toe flexure (2′) having a first toe end (2a′) and a second toe end (2b′). A resilient heel flexure (3′) having a front heel end (3a′) and a bottom heel end (3b′). A support member (6) rigidity secures the resilient toe flexure (2′) with the resilient heel flexure (3′) wherein the vertical plane (VP) of the mobility aid tip is offset (θ) with the axis of the mobility aid (y-y) and the first toe end (2a′) is positioned forwardly from the axis of the mobility aid (y-y). The bottom heel end (2b′) is positioned rearwardly from the axis of the mobility aid (y-y) and a toe pad (4′) secures the front toe end (2a′) of the toe flexure (2′) and a heel pad (5′) secures the bottom heel end (3b′) of the heel flexure (3′).

### BRIEF DESCRIPTION OF FIGURES

The novel features and characteristics of the disclosure are set forth in the description. The disclosure itself, however, as well as a preferred mode of use, further objectives and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 (a) and FIG. 1 (b) illustrates the traditional/conventional crutch along with the traditional crutch tip available in the prior art.

FIGS. 2(a) and 2(b) illustrates the location of various medical side effects induced in the body due to usage of conventional crutches for longer duration of time.

FIGS. 3(a) and 3(b) illustrates the limitations of traditional/conventional crutches on difficult terrain.

FIG. 4 illustrates the isometric view of a person using the mobility aid in accordance with the embodiment and alternate embodiment of the present disclosure. It also illustrates the defined planes Coronal, Sagittal and Ground/Transverse plane with respect to the human user

FIG. 5 illustrates the Ground/Transverse plane and VP—Vertical plane of the tip with respect to the disclosed mobility aid tip kept on the ground.

FIG. 6 (a) illustrates the isometric view of the mobility aid tip in accordance with the embodiment of the present disclosure.

FIG. 6 (b) illustrates the exploded view of the mobility aid tip in accordance with the embodiment of the present disclosure.

FIG. 6 (c) illustrates the different views of the mobility aid tip in accordance with the embodiment of the present disclosure.

FIG. 7 (a) illustrates the isometric view of the mobility aid tip in accordance with the alternate embodiment of the present disclosure.

FIG. 7 (b) illustrates the exploded view of the mobility aid tip in accordance with the alternate embodiment of the present disclosure.

FIG. 7 (c) illustrates the different views of the mobility aid tip in accordance with the alternate embodiment of the present disclosure.

FIG. 8 illustrates the user body weight and ground reaction force when load is applied on the mobility aid tip in accordance with the embodiment of the present disclosure.

FIGS. 9 and 10 illustrates the rear view of the mobility aid tip showing the offset of the mobility aid tip axis with respect to the mobility aid axis. The diagram shows the mobility aid to be used on the right side. The tip to be used on left side will be mirror image of the illustration.

FIG. 11 (a) illustrates the perspective view of the mobility aid in accordance with the embodiment and alternate embodiment of the present disclosure.

FIGS. 11 (b) and 11(c) illustrates the front view and side view of the mobility aid respectively in accordance with the embodiment and alternate embodiment of the present disclosure

FIG. 12 (a) illustrates the front view of an alternate mobility aid in accordance with the embodiment and alternate embodiment of the present disclosure.

FIGS. 12 (b) and 12 (c) illustrates the side view and isometric view respectively in accordance with the embodiment and alternate embodiment of the present disclosure

FIG. 13 illustrates the rollover of the mobility aid tip along with the mobility aid in accordance with the embodiment and alternate embodiment of the present disclosure.

FIG. 14 illustrates the different forces acting on the tip of the mobility aid in accordance with the embodiment and alternate embodiment of the present disclosure.

FIG. 15 illustrates the front view of a person using the mobility aid in accordance with the embodiment and alternate embodiment of the present disclosure.

FIG. 16 illustrates the side view of a person using the mobility aid in accordance with the embodiment and alternate embodiment of the present disclosure.

FIG. 17 illustrates the trajectory followed by the sacrum of person using a traditional mobility aid tip fitted on an axillary crutch (Dashed line) and the disclosed mobility aid tip fitted on the same axillary crutch (solid line). The trajectory is not according to scale and is for visual understanding only.

### DETAILED DESCRIPTION OF THE PRESENT DISCLOSURE

While the invention is subject to various modifications and alternative forms, specific embodiment thereof has been shown by way of example in the figures and will be described below. It should be understood, however that it is not intended to limit the invention to the particular forms disclosed, but on the contrary, the invention is to cover all modifications, equivalents, and alternative falling within the scope of the invention.

It is to be noted that a person skilled in the art can be motivated from the present invention and can perform various modifications. However, such modifications should be construed within the scope of the invention.

Accordingly, the drawings are showing only those specific details that are pertinent to understanding the embodiments of the present invention so as not to obscure the disclosure with details that will be readily apparent to those of ordinary skill in the art having benefit of the description herein.

The terms “comprises”, “comprising”, or any other variations thereof, are intended to cover a non-exclusive inclusion, such that an assembly, setup, system, device that comprises a list of components does not include only those components but may include other components not expressly listed or inherent to such system or device or setup. In other words, one or more elements in the system or apparatus or device proceeded by “comprises a” does not, without more constraints, preclude the existence of other elements or additional elements in the assembly or system or apparatus. The following paragraphs explain present invention.

Accordingly, the present disclosure relates to a mobility aid tip (1) comprising a resilient toe flexure (2) having a first toe end (2a) and a second toe end (2b), a resilient heel flexure (3) having a front heel end (3a) and a bottom heel end (3b) wherein the axis of the mobility aid tip (x-x) is offset (θ) with the vertical plane (VP) of the mobility aid tip (1); the first toe end (2a) is positioned forwardly from the axis of the mobility aid (y-y) and the bottom heel end (3b) is positioned rearwardly from the axis of the mobility aid (y-y); a toe pad (4) secures the first toe end (2a) of the toe flexure (2) and a heel pad (5) secures the bottom heel end (3b) of the heel flexure (3).

Accordingly, in the alternate embodiment of the present disclosure relates to mobility aid tip (10) comprising a resilient toe flexure (2′) having a first toe end (2a′) and a second toe end (2b′), a resilient heel flexure (3′) having a front heel end (3a′) and a bottom heel end (3b′), a support member (8′) rigidity secures the resilient toe flexure (2′) with the resilient heel flexure (3′) wherein the axis of the mobility aid tip (x-x) is offset (θ) with the vertical plane (VP) of mobility aid tip (1), the first toe end (2a′) is positioned forwardly from the axis of the mobility aid (y-y) and the bottom heel end (2b′) is positioned rearwardly from the axis of the mobility aid (y-y), a toe pad (4′) secures the first toe end (2a′) of the toe flexure (2′) and a heel pad (5′) secures the bottom heel end (3b′) of the heel flexure (3′).

In another embodiment of the present disclosure wherein a connector (6) is positioned at the top of the first toe end (2a) which secures strut (103,203) of the mobility aid (100,200) thereby connecting the mobility aid tip (1) with mobility aid (100,200).

In yet another embodiment of the present disclosure wherein a support member (8′) comprises a connector (6′) which secures strut (103,203) of the mobility aid (10) thereby connecting the mobility aid tip (1) with mobility aid (100,200).

In a further embodiment of the present disclosure wherein the first toe end (2a, 2a′) is having a curvature allowing the toe flexure (2, 2′) to roll on the walking surface.

In a further embodiment of the present disclosure the bottom heel end (2b,2b′) is having a curvature allowing the heel flexure (3,3′) to roll on the walking surface

In an alternate embodiment of the present disclosure wherein the toe pad (4,4′) and the heel pad (5,5′) is having a curvature.

In another embodiment of the present disclosure wherein the first toe end (1a, la′) moves forward relative to the heel flexure (3,3′) during the body swing phase or when the weight is applied on the mobility aid tip (1,10) or during the mobility aid stance phase.

In one more embodiment of the present disclosure wherein the footprint area of the mobility aid tip increases during the application of weight on the mobility aid tip resulting in higher grip strength and stability

In another embodiment of the present disclosure wherein a top end (8a′) of the support member (8′) is connected with the first toe end (2a′) by means of rivets (7′) or welding or any other suitable mechanism.

In a further embodiment of the present disclosure wherein a bottom end (8b′) of the support member (8) is connected with the front heel end (3a′) by means of rivets (7′) or welding or any other suitable mechanism.

In a further embodiment of the present disclosure wherein the toe pad (4,4′) and heel pad (5, 5′) is made up of rubber or any other griping material.

In yet another embodiment of the present disclosure wherein the toe flexure (2,2′) and the heel flexure (3,3′) remains flat on the ground during the working of the mobility aid tip (1, 10).

In an alternate embodiment of the present disclosure wherein toe pad (4,4′) and the heel pad (5,5′) has uniform wear and hence increased durability of the gripping material.

In one more embodiment of the present disclosure wherein the toe flexure (2, 2′) comprises at least a slit (2c, 2c′) dividing the face of the toe flexure (2,2′) partly

Accordingly, the present disclosure relates to a mobility aid (100,200) comprising a shoulder rest (101,201), a handgrip (102,202) and a strut (103,203) connected with a mobility aid tip (1) wherein the mobility aid tip (1) comprises a resilient toe flexure (2) having a first toe end (2a) and a second toe end (2b) a resilient heel flexure (3) having a front heel end (3a) and a bottom heel end (3b) wherein the axis of the mobility aid tip (x-x) is offset (θ) with the vertical plane (VP) of the mobility aid tip (1); the first toe end (2a) is positioned forwardly from the axis of the mobility aid (y-y) and the bottom heel end (3b) is positioned rearwardly from the axis of the mobility aid (y-y); a toe pad (4) secures the first toe end (2a) of the toe flexure (2) and a heel pad (5) secures the bottom heel end (3b) of the heel flexure (3).

Accordingly, the present disclosure relates to a mobility aid (100,200) comprising a shoulder rest (101,201), a handgrip (102,202) and a strut (103,203) connected with a mobility aid tip (1) wherein the mobility aid tip (10) comprising a resilient toe flexure (2′) having a first toe end (2a′) and a second toe end (2b′), a resilient heel flexure (3′) having a front heel end (3a′) and a bottom heel end (3b′), a support member (8′) rigidity secures the resilient toe flexure (2′) with the resilient heel flexure (3′) wherein the axis of the mobility aid tip (x-x) is offset (θ) with the vertical plane (VP) of mobility aid tip (10), the first toe end (2a′) is positioned forwardly from the axis of the mobility aid (y-y) and the bottom heel end (2b′) is positioned rearwardly from the axis of the mobility aid (y-y) a toe pad (4′) secures the first toe end (2a′) of the toe flexure (2′) and a heel pad (5′) secures the bottom heel end (3b′) of the heel flexure (3′).

The present disclosure is driven by the need to create an ergonomically and effective mobility aid, which has the features incorporated to have medical, stability and usability benefits over conventional crutches. The long-term usage of conventional crutches leads to crutch palsy, nerve damage in axilla which may leads to paralysis. The patient walking with three-point gait mobility aid using a traditional mobility aid tip has too many ergonomic issues while using axillary crutches. The problems are vertical motion of upper body, shock absorption by hands and lateral motion of crutch tip during crutch swing phase, slippage of crutch tip in wet surfaces, wear of rubber tip due to concentrated load and non-adaptability to various kinds of terrains. The user feels discomfort if the height of crutch is varying on resting their body in standing posture.

In the present disclosure the Inventor (s) have implemented and use a flexible kinetic shape or in layman's terms a metal sheet in a specific shape. The Kinetic shape and dynamic characteristics of the design helps the user in spending less energy, higher stability on uneven and rough walking surfaces, extended durability, and higher shock absorption as compared to available conventional crutch. In detail, it absorbs the impact when the person tries to propel, and it causes the body to move very little against the gravity, and later while the person tries to lift the crutch for the next gait motion, the stored energy is released leading to the easier lifting of crutches. The ultimate result for a user is that less energy is used for movement and there are no impact forces conveyed to the body thus mitigating side effects.

The unique design of mobility aid (100,200) is that it has a heel member extended rearward and toe member extended forwardly. The mobility aid tip (1,10) deforms in vertical direction (x-x) on loading. A lateral movement of the mobility aid tip (1,10) is adopted by the user (after the end of one gait cycle and before the next gait cycle start) to shorten the vertical movement of the crutch in order to displace the crutch further forward. The user has to either raise the crutch or move it laterally to ensure the tip has no contact with ground during body stance phase (when the leg is supporting the weight of the user). Since the toe part stores the energy by deflecting during the end of the body swing, it helps in swinging the crutch, therefore he need not spend energy in raising the crutch. The heel strike point (ground reaction) and crutch longitudinal axis results in moment, which leads to propulsion. The conventional crutches have a pointed tip, whereas the flex-crutch has surfaces in contact with the ground, and lateral flexibility due to longitudinal cut over heel and toe helps in conformity to different terrains, thereby decreasing the chances of slippage. The conventional crutches tip with bottom surface perpendicular to the longitudinal axis of the crutch. In actual usage, the crutch makes a lateral angle with the ground resulting in uneven wear of the tip. In the present design, the crutch bottom surface conforms to the ground, uniformly distributing the weight of the user therefore reducing uneven wear. The vertical axis of tip is not aligned with the axis of the crutch. It is arranged in such away the bottom surface is fully contact with the ground in crutch stance phase (when the crutch or mobility aid is supporting the weight of the user). The heel and toe flexures has different stiffness. The toe stiffness is low compared with heel.

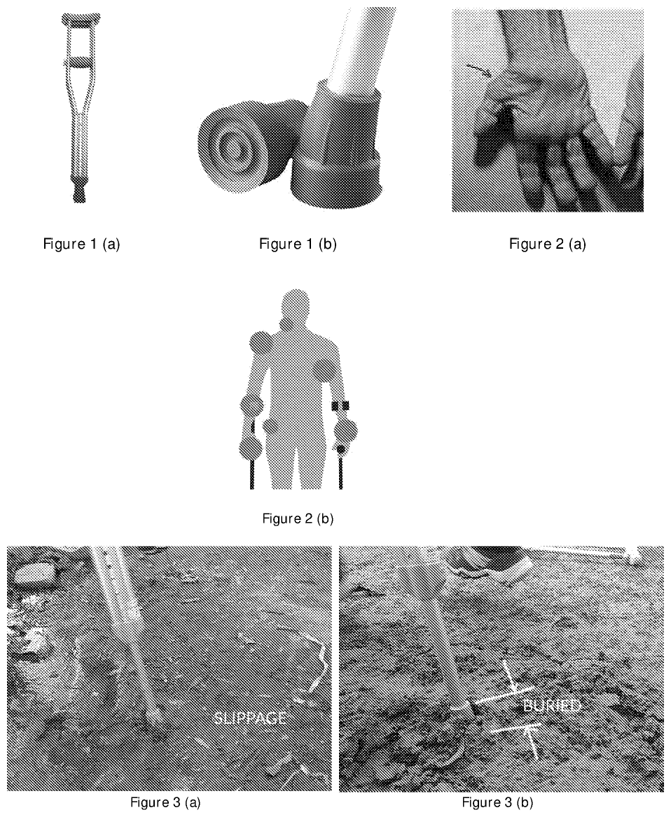

The following paragraphs describe the present disclosure with reference to FIGS. 1 to 17 according to an embodiment of the present description.

In the present disclosure the term “a mobility aid” refers to all the kind of mobility aids such as “crutch” or “cane” or “walking stick” and these terms are interchangeably are used in the specification referring to same meaning. Also the tip of the mobility aid or the mobility aid tip or tip is interchangeably used referring to the same meaning.

The present disclosure is directed towards to a tip of the mobility aid where two resilient metal leaves are attached to form a structure which provides mechanical advantage and enables the patients to walk with the mobility aid.

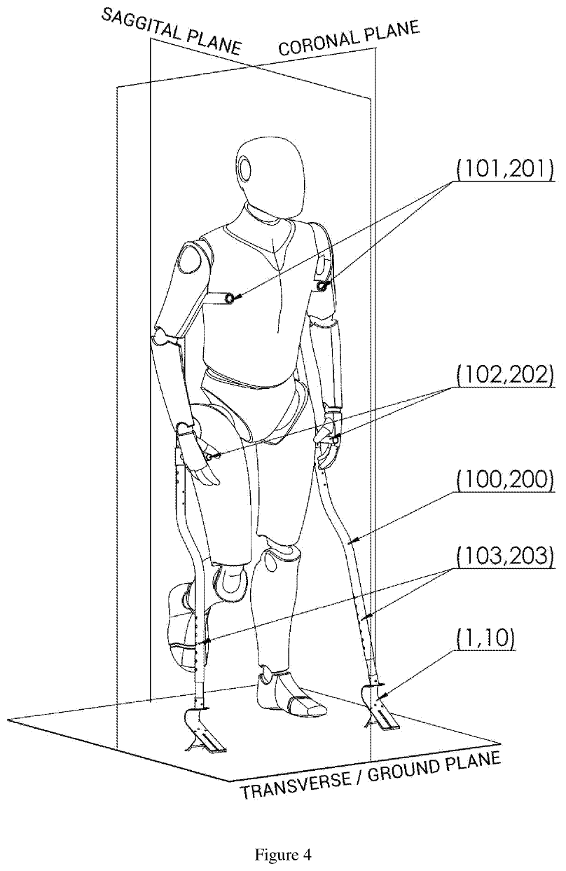

FIG. 4 illustrates the isometric view of a user walking with the mobility aid (100,200) and three planes defined with respect to human body. This becomes the reference to define further planes. A transverse (also known as axial or horizontal) plane is parallel to the ground; in humans it separates the superior from the inferior, or put another way, the head from the feet. A coronal (also known as frontal or lateral) plane is perpendicular to the ground; in humans it separates the anterior from the posterior, the front from the back, the ventral from the dorsal. A sagittal (also known as anteroposterior) plane is perpendicular to the ground, separating left from right. The midsagittal plane is the specific sagittal plane that is exactly in the middle of the body.

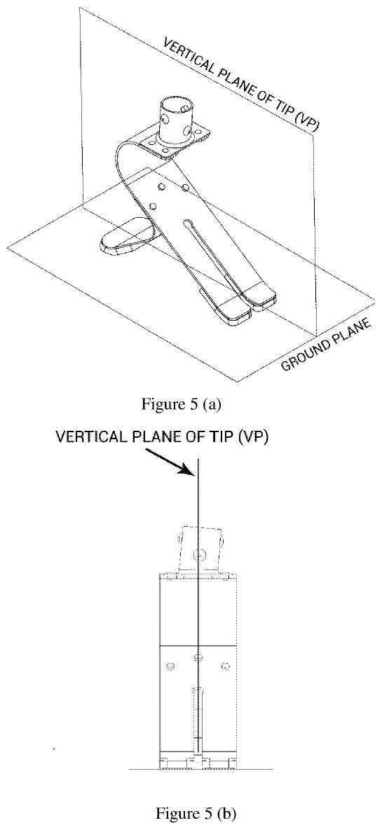

FIG. 5 illustrates the definition of the reference planes of the mobility aid tip (1,10). Transverse/Ground plane is the plane parallel and coincident to a flat surface when the mobility aid tip (1,10) is resting on it in the position shown. The vertical plane (referred to as VP) of the tip (1,10) is the plane perpendicular to the ground plane, and divides the mobility aid tip (1,10) along the midline.

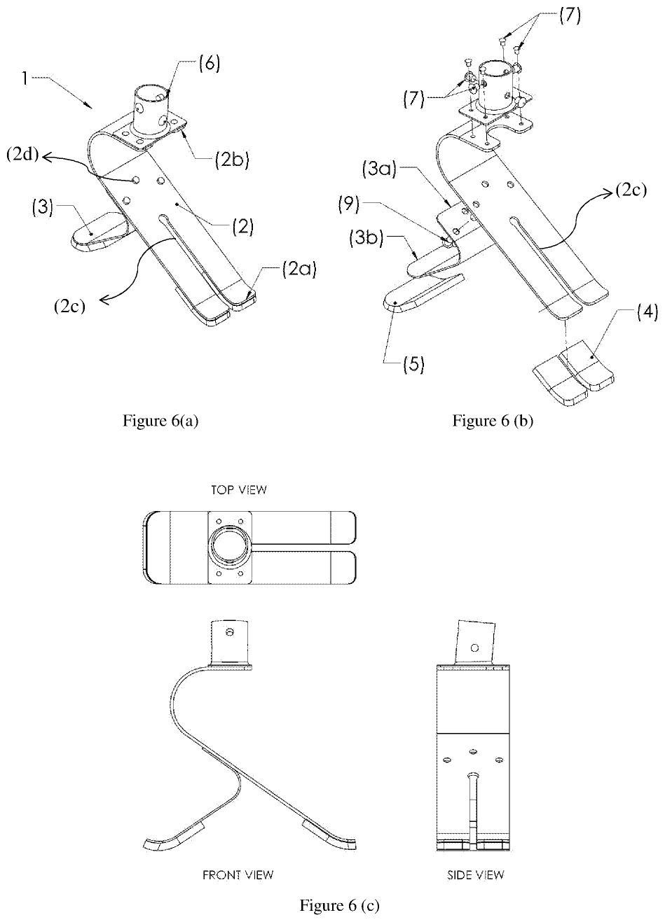

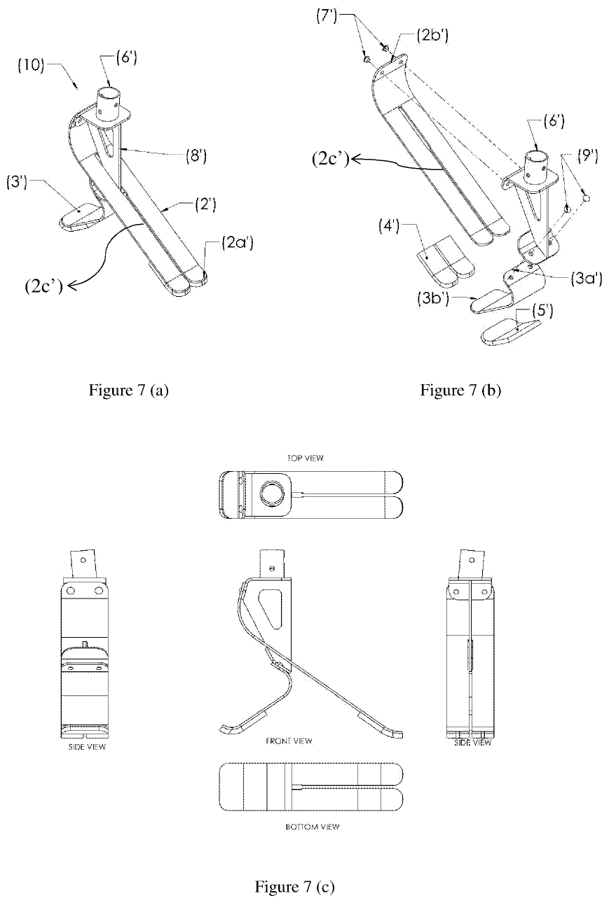

FIG. 6 illustrates the isometric view of the mobility aid tip in accordance with the embodiment of the present disclosure and FIG. 7 illustrates the perspective view of the mobility aid tip in accordance with the alternate embodiment of the present disclosure.

As illustrated in FIGS. 6 and 7 a mobility aid tip (1,10) comprising a resilient toe flexure (2,2′). The toe flexure (2,2′) is having two ends with first a first toe end (2a, 2a′) and a second toe end (2b, 2b′). The face of the toe flexure (2,2′) is also having a slit (2c, 2c′) which extends longitudinally from the first end (2a,2a′) of the toe flexure (2a, 2a′) which divides the face of the toe flexure (2,2′) partly. The slit (2c,2c′) does not divide the face of the toe flexure (2,2′) fully but extends up to certain length away from the first end (2a,2a′) of the toe flexure (2,2′) and towards the second end (2b,2b′) of the toe flexure (2,2′). In an embodiment of the present disclosure single slit (2c,2c′) is present in the face of the toe flexure (2,2′), however more than one slit (2c,2c′) may also be present which divides the face of the toe flexure (2,2′) partly. The face of the toe flexure (2) is also having one or more cavity (2d) through which rivets (9) passes and rigidity connects the toe flexure with a resilient heel flexure (3).

The resilient heel flexure is having front heel end (3a,3a′) and a bottom heel end (3b,3b′). In one possible embodiment (1) of the present disclosure, the front heel end (3a) is rigidity fixed with the cavity (2d) present in the face of the toe flexure (1) using rivets (9) thereby forming a single structure and the bottom heel end touches the ground or surface when the mobility aid is used by the user. A connector (6) is also positioned at the top of the first toe end (2a) which secures a strut (103,203) of the mobility aid (100,200) thereby connecting the mobility aid tip (1) with the mobility aid (100,200) using rivets (7)

In an alternative embodiment (10), the front heel end (3a′) is rigidly secured with the connector (6′) using rivets (9′) which in turn is rigidly secured to the second end of the toe flexure (2b′) using rivets (7′). The mobility aid tip (10) comprises a support member (8′) which rigidity secures the resilient toe flexure (2′) with the resilient heel flexure (3′) by means of rivets (7′,9′). The support member (8′) comprises a connector (6′) which secures a strut (103,203) of the mobility aid (10) thereby connecting the mobility aid tip (1) with the mobility aid (100,200).

Further, the first toe end (2a, 2a′) and the bottom heel end (3b,3b′) is having a curvature which allows the toe flexure (2, 2′) and the heel flexure (3,3′) to roll on the walking surface. The toe pad (4,4′) and the heel pad (5,5′) is also having curvature.

The mobility aid tip (1,10) also comprises a toe pad (4, 4′) which secures the first toe end (2a.2a′) of the toe flexure (2,2′). The toe pad (4,4′) covers the first toe end (2a,2a′) of the toe flexure (2,2′) fully and touches the ground when the mobility aid (100,200) is used by the user. A heel pad (5,5′) is also present which secures the bottom heel end (3b,3b′) of the heel flexure (3,3′) completely and covers the bottom heel end (3b,3b′) fully. The toe pad (4,4′) and heel pad (5, 5′) is made up of rubber or any other griping material.

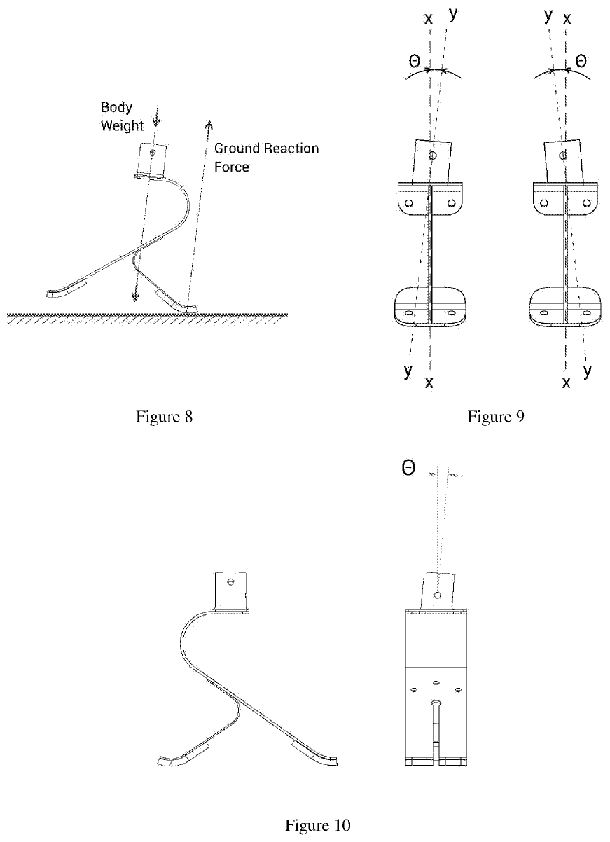

Further as shown in FIG. 8, the construction of the mobility aid tip (1,10) is such that the both the heel (3,3′) and toe flexure (2,2′) are in parallel connection to the mobility aid body. There is a slight offset angle (θ) shown in FIG. 9 provided between the axis of the mobility aid (y-y) and the vertical plane of the mobility aid tip on which the line (x-x) lines. This offset angle will ensure that the flexures (2, 2′, 3, 3′) are held flat to the ground while the user is holding the mobility aid. The flat contact leads to a uniform wear of the gripping material.

In an embodiment of the present and as illustrated in FIGS. 9 and 10, the mobility aid axis is offset (θ) with respect of the vertical plane (VP) of the mobility tip (1,10). The axis of the mobility aid (y-y) is defined as the longitudinal axis passing through the center of the strut of the mobility aid. The offset angle is defined as the angle between the vertical plane (VP) and the axis of the mobility aid (y-y)

In an embodiment of the present disclosure, the first toe end (2a,2a′) is positioned forwardly from the axis of the mobility aid (y-y) and the bottom heel end (3b,3b′) is positioned rearwardly from the axis of the mobility aid (y-y).

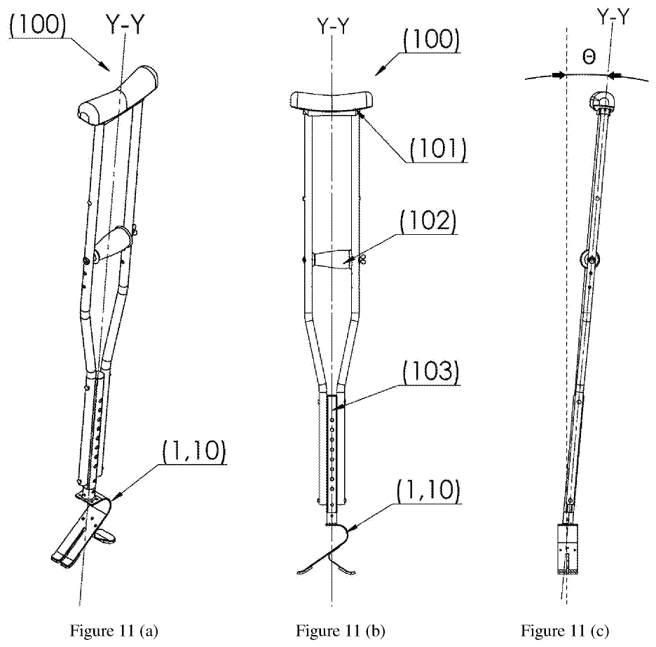

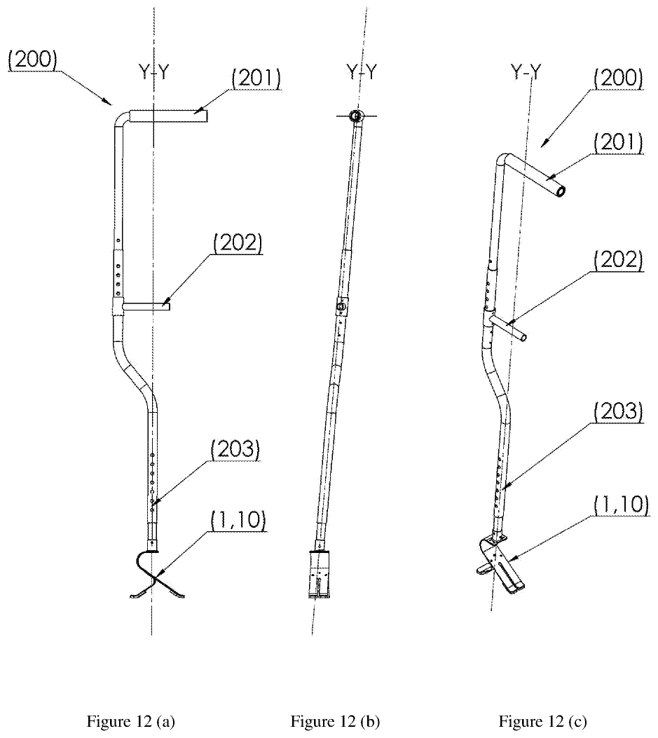

FIGS. 11 and 12 illustrates a mobility aid (100,200) comprising a shoulder rest (101,201) a handgrip (102,202) and a strut (103,203) connected with a mobility aid tip (1,10).

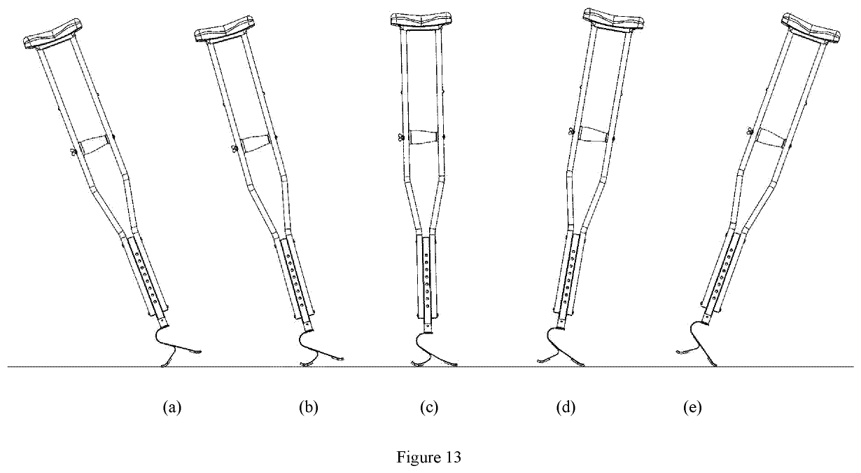

The mobility aid ambulation has been demonstrated in a forward motion as shown in 13. As illustrated in FIG. 13 (a) initially mobility aid (100,200) backward tip i.e. heel part (3,3′) is rested on the ground which takes up the weight of the person walking using the mobility aid (100, 200) and it damps the effect of heel strike. The axis of crutch (y-y) is at a horizontal offset from the heel (3,3′) as shown in FIG. 8. This offset (θ) converts the body weight in to a rollover moment. Moreover, the deformation causes the effective length of the mobility aid (100,200) to decrease slightly. This increases stability as felt by the patient in body standing posture. The momentum gain in the first half of the cycle helps the next half movement. The toe part (2,2′) of the mobility aid (100,200) which again restores some energy gained through left over momentum carried by the body and releases the energy in the form of raising of crutch (100,200) next gait cycle, as demonstrated in FIG. 13(e).

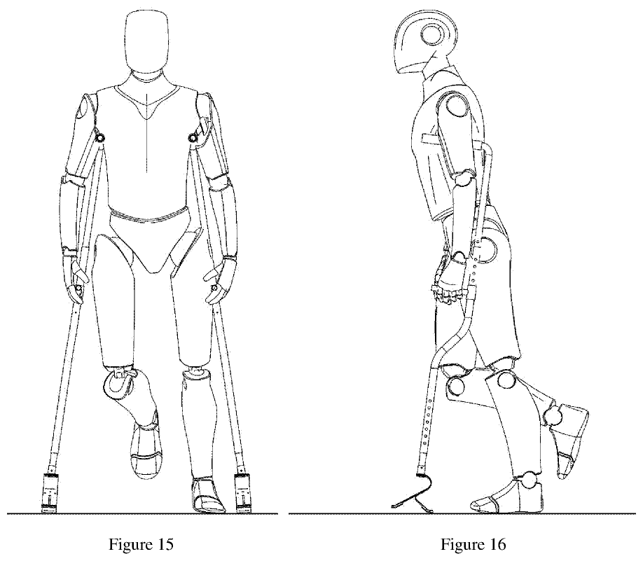

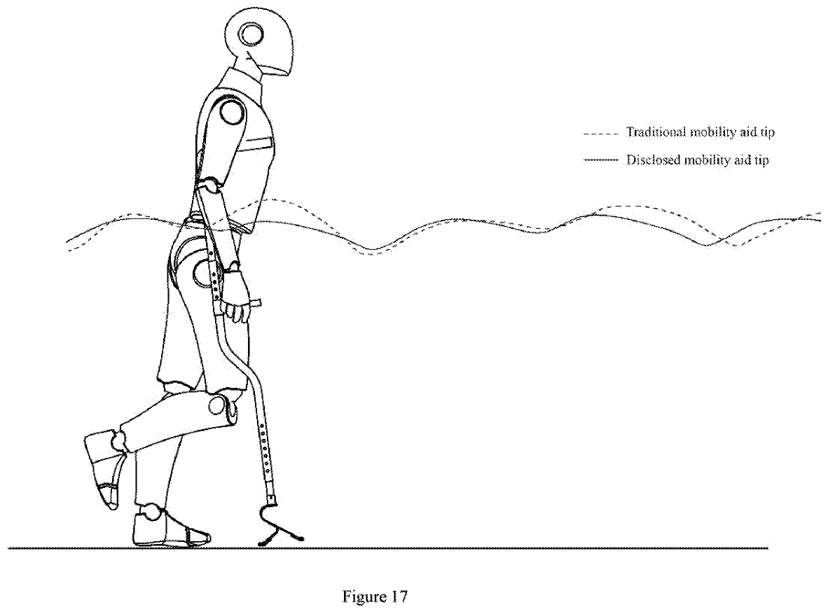

The construction of the mobility aid (100,200) is such that the both the heel and toe flexure are in parallel connection to the mobility aid body. There is an offset angle (θ) which will ensure that the flexures (2, 2′,3,3′) are held flat to the ground while the user is holding the crutches as shown in FIG. 15-16. The flat contact leads to a uniform wear of the gripping material. The heel flexure (3,3′) is the first flexure that meets the ground when the user swings the mobility aid (100,200) forward and as the user lunges forward, the heel (3,3′) absorbs the jarring energy and deforms. The axis of crutch is at a horizontal offset from the heel. The stiffness of the heel flexure (3,3′) changes as a function of the roll over angle in such a way that the stiffness is maximum when the mobility aid (100,200) is vertical and minimal when it is at the extreme angles. This increases stability as felt by the patient.

As the mobility aid (reaches a vertical position as shown in FIG. 13 (c), the toe flexure contacts the ground and deforms absorbing further inertia. At the end of the body-swing, the toe flexure (2,2′) absorbs the inertia and thereby reducing the jarring forces absorbed by the lower leg. The slit (2,2c′) along the flexures will conform to the ground even if it is uneven. The deformation of both the flexure and the corresponding reduction in effective length make the center of gravity of the user to move in a fairly less convex path with minimal raise against gravity. This is as opposed to nearly circular trajectory followed by traditional crutches. This path reduces the energy required to lunge. As the user now starts lifting the crutch from back to keep it in front, the deformed toe flexure springs back and propels the crutch forward significantly easing the lifting of crutch and swing it forward.

The underside of the toe and heel flexure are layered with a soft gripping material. These grips individually prevent the slippage of crutch during start and end of gait. But together, they also prevent rotation of crutch along the longitudinal axis thus mitigating any wobble.

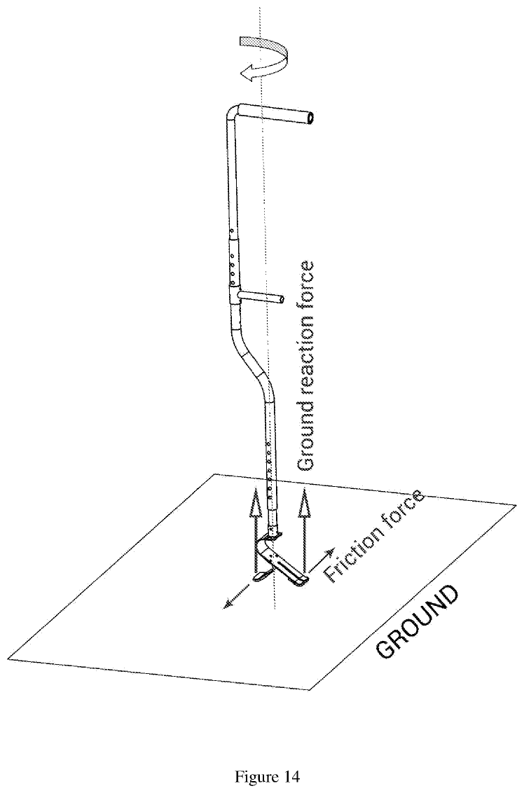

As shown in FIG. 14, the distal part of the mobility aid (100,200) is subjected to forces acting in both the sagittal and transverse plane. The forces in the sagittal plane results in frictional forces in transverse plane as shown in the FIG. 5. The frictional forces at the heel (3,3′) and toe (2,2′) part impart frictional torque which prevent the mobility aid (100,200) from twisting along the longitudinal axis of crutch. The YAW resistance assist the user by providing higher stability and resistance to twist while swinging. The user spent much energy in stabilizing his joints against this motion while using traditional crutch.

FIG. 15 is the front view of a user holding the crutches in a position just before he starts walking. The tips are held approximately 6 inch sideways away from the closest point of feet. In such a natural position the mobility aid tip rests flat on the ground. FIG. 16 shows the side view of a user holding the crutches in a position just before he starts walking. The tips are held approximately 6 inches front of the closest point feet.

It is to be noted that FIGS. 15 and 16 are different views of the same position. One of the leg is shown as bent to signify the injured or disabled leg. Users who have undergone amputation will only have a stump instead of the bent leg.

FIG. 17 shows the relative trajectory of the body's center of gravity (approximated to be same as position of Sacrum) when using a traditional rigid mobility aid tip or almost rigid (represented by dotted line) compared to the mobility aid tip disclosed in this patent (represented by solid line).

Thus the individual functions of the present disclosure add up to the advantages such as reduction of energy needed for the Gait motion. One more advantage of the present disclosure is to reduce the jarring forces the body experiences and thereby reducing risk factors in medical side effects. Yet another advantage of the present disclosure is that the two-point contact provided by the toe and heel ensure stability during the motion on flat ground and stairs as well while descending. One more advantage of the present disclosure is that is increase the lifespan of the gripping material in rough terrain and also provides stability on uneven and rough terrain.

### EQUIVALENTS

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

### LIST OF REFERENCE NUMERALS

| | |
|---|---|
| Mobility aid tip | (1, 10) |
| Resilient Toe Flexure | (2, 2′) |
| First Toe End | (2a, 2a′) |
| Second Toe End | (2b, 2b′) |
| Resilient Heel Flexure | (3, 3′) |
| Front Heel End | (3a, 3a′) |
| Bottom Heel End | (3b, 3b′) |
| Toe Pad | (4, 4′) |
| Heel Pad | (5, 5′) |
| Connector | (6, 6′) |
| Rivets | (7, 7′) |
| Support Member | (8′) |
| Top End of Support Member | (8a′) |
| Bottom End Support Member | (8b′) |
| Rivets | (9′) |
| Mobility aid | (100, 200) |
| Shoulder rest | (101, 201) |
| Handgrip | (102, 202) |
| Strut | (103, 203) |
| Mobility Aid Tip axis | (x-x) |
| Mobility Aid axis | (y-y) |
| Offset | (θ) |
| Vertical Plane | (VP) |

1. A mobility aid tip comprising:
a resilient toe flexure having a first toe end and a second toe end
a resilient heel flexure having a front heel end and a bottom heel end wherein the axis of the mobility aid tip is offset with the vertical plane of the mobility aid tip;
the first toe end is positioned forwardly from the axis of the mobility aid and the bottom heel end is positioned rearwardly from the axis of the mobility aid;
a toe pad secures the first toe end of the toe flexure and a heel pad secures the bottom heel end of the heel flexure.

2. A mobility aid tip comprising:
a resilient toe flexure having a first toe end and a second toe end
a resilient heel flexure having a front heel end and a bottom heel end
a support member rigidity secures the resilient toe flexure with the resilient heel flexure wherein the axis of the mobility aid tip is offset with the vertical plane of the mobility aid tip,
the first toe end is positioned forwardly from the axis of the mobility aid and the bottom heel end is positioned rearwardly from the axis of the mobility aid;
a toe pad secures the first toe end of the toe flexure and a heel pad secures the bottom heel end of the heel flexure.

3. The mobility aid tip as claimed in claim 1 wherein a connector is positioned at the top of the first toe end which secures strut of the mobility aid thereby connecting the mobility aid tip with mobility aid.

4. The mobility aid tip as claimed in claim 1 wherein the connector is connected with the second toe end by means of rivets or welding or any other suitable mechanism.

5. The mobility aid tip as claimed in claim 2 wherein a support member comprises a connector which secures strut of the mobility aid thereby connecting the mobility aid tip with mobility aid.

6. The mobility aid tip as claimed in claim 1 wherein the first toe end is having a curvature allowing the toe flexure to roll on the walking surface.

7. The mobility aid tip as claimed in claim 1 wherein the bottom heel end is having a curvature allowing the heel flexure to roll on the walking surface.

8. The mobility aid tip as claimed in claim 1 wherein the toe pad and the heel pad is having a curvature.

9. The mobility aid tip as claimed in claim 1 wherein the first toe end moves forward relative to the heel flexure during the body swing phase or when the weight is applied on the mobility aid tip or during the mobility aid stance phase.

10. The mobility aid tip as claimed in claim 6 wherein the footprint area of the mobility aid tip increases during the application of weight on the mobility aid tip resulting in higher grip strength and stability

11. The mobility aid tip as claimed in claim 2 wherein a top end of the support member is connected with the second toe end by means of rivets or welding or any other suitable mechanism.

12. The mobility aid tip as claimed in claim 2 wherein a bottom end of the support member is connected with the front heel end by means of rivets or welding or any other suitable mechanism.

13. The mobility aid tip as claimed in claim 1 wherein the toe pad and heel pad is made up of rubber or any other griping material.

14. The mobility aid tip as claimed in claim 1 wherein the toe flexure and the heel flexure remains flat on the ground during the working of the mobility aid tip.

15. The mobility aid tip as claimed in claim 11 wherein toe pad and the heel pad has uniform wear and hence increased durability of the gripping material.

16. The mobility aid tip as claimed in claim 1 wherein the toe flexure comprises at least a slit dividing the face of the toe flexure partly.

17. A mobility aid comprising:
a shoulder rest
a handgrip and
a strut connected with a mobility aid tip wherein
the mobility aid tip comprises a resilient toe flexure having a first toe end and a second toe end
a resilient heel flexure having a front heel end and a bottom heel end wherein the axis of the mobility aid tip is offset with the vertical plane of the mobility aid tip;
the first toe end is positioned forwardly from the axis of the mobility aid and
the bottom heel end is positioned rearwardly from the axis of the mobility aid;
a toe pad secures the first toe end of the toe flexure and a heel pad secures the bottom heel end of the heel flexure.

18. A mobility aid comprising:
a shoulder rest
a handgrip and
a strut connected with a mobility aid tip wherein
the mobility aid tip comprising
a resilient toe flexure having a first toe end and a second toe end
a resilient heel flexure having a front heel end and a bottom heel end
a support member rigidity secures the resilient toe flexure with the resilient heel flexure wherein the axis of the mobility aid tip offset with the vertical plane of mobility aid tip;
the first toe end is positioned forwardly from the axis of the mobility aid and the bottom heel end is positioned rearwardly from the axis of the mobility aid;
a toe pad secures the first toe end of the toe flexure and a heel pad secures the bottom heel end of the heel flexure.
